(19) United States
(12) Patent Application Publication
(10) Pub. No.: US 2026/0217025 A1
(43) Pub. Date: Jul. 30, 2026

(54) PRINTHEAD FOR AN INKJET PRINTER, IN PARTICULAR COATING PRINT MEDIA

(71) Applicant: Durst Group AG, Brixen (IT)

(72) Inventors: Clemens DEJACO, Rodeneck (IT); Stefan WALDNER, Mals (IT)

(21) Appl. No.: 19/146,160

(22) PCT Filed: Feb. 28, 2024
(86) PCT No.: PCT/EP2024/025092

§ 371 Date: Jul. 7, 2025

(30) Foreign Application Priority Data
Mar. 8, 2023 (IT) 102023000004104

(51) Int. Cl. B41J 2/14; B41J 2/175

(52) U.S. Cl. CPC B41J 2/14201; B41J 2/175

(57) ABSTRACT

Printhead for an inkjet printer, wherein the printhead comprises at least one ink supply channel and at least one nozzle with a nozzle channel and an inflow opening, wherein ink from the ink supply channel can be pressed through the inflow opening into the nozzle channel and ejected therefrom, wherein the nozzle is arranged in a stationary manner on a sidewall of the ink supply channel and the at least one nozzle is assigned a plunger having a plunger front face located in the ink supply channel opposite and spaced from the inflow opening, wherein the printhead comprises first means for moving the plunger front face in the ink supply channel between a reversal point (U1) minimally spaced from the inflow opening of the nozzle and a reversal point (U2) maximally spaced from the inflow opening of the nozzle, the first means limiting the movement of the plunger front face to a movement between the reversal points (U1, U2), and second means for applying a negative pressure to the ink in the ink supply channel relative to ambient air pressure, wherein at least one set of said nozzles is provided comprising the one nozzle, wherein a single plunger is assigned to all nozzles of the one set of nozzles.

The present invention relates to a printhead for an inkjet printer according to the preamble of claim 1, as well as to a method for performing printing processes according to the preamble of claim 17.

Devices and methods for coating print media are typically used to apply at least one coating as uniformly as possible, which serves specific functional and/or decorative purposes and is intended to improve the surface properties of the print media. Non-contact coating methods are preferably used when relatively high coating speeds are to be worked with.

In non-contact application methods and in the devices based on such methods, it is crucial not only to ensure the possibly most uniform possible discharge of ink across a specific discharge width of the printhead but also to achieve the most uniform possible application of ink over a defined coating width of the print medium.

For coating ceramic print media, non-contact methods are typically used to refine their surfaces, most commonly involving a glaze suspension.

A known printhead for coating a print medium is designed to apply ink to its surface by ejecting ink droplets from independently controllable nozzles of the printhead onto the print medium to be coated.

WO2013013983A1, for example, discloses such a printhead, which is designed as a drop-on-demand (DOD) printhead. It includes an ink supply channel and at least one nozzle with a nozzle channel and an inflow opening, through which ink can be pressed from the ink supply channel into the nozzle channel and expelled from it and whereby the one nozzle is associated with a plunger whose front face lies in the ink supply channel opposite the inflow opening at a distance and whereby several nozzles are present in the ink supply channel, each with its associated plunger.

This known printhead comprises first means for moving the plunger face within the ink supply channel between a reversal point (U1) minimally spaced from the nozzle's inflow opening and a reversal point (U2) maximally spaced from the nozzle's inflow opening.

This known plunger-operated printhead is suitable for the uniform discharge and application of glaze suspension onto print media, especially when a relatively large amount of glaze suspension is to be dispensed per nozzle and unit of time. However, due to its complex construction, it requires significant manufacturing effort and exhibits relatively high susceptibility to malfunction. Consequently, both the acquisition and, in particular, the maintenance of such a printhead are relatively costly. In fact, drop-on-demand (DOD) printheads and printing methods are, by their nature, typically not intended for printing broad or full areas, but rather for producing any conceivable complex and fine patterns on print media.

Additionally, plunger-operated printheads generally have a relatively high energy consumption per amount of ink discharged per nozzle.

There is therefore a need for a plunger-operated drop-on-demand (DOD) printhead with multiple nozzles that enables efficient ink discharge from its nozzles using a simpler and more cost-effective construction and, in particular, that has a lower energy consumption per amount of ink discharged per nozzle.

The objective of the present invention is thus to provide a plunger-operated drop-on-demand (DOD) printhead with multiple nozzles, which allows for efficient ink discharge using a construction that is simpler and more economical, and that, in particular, reduces the energy consumption per amount of ink discharged per nozzle.

According to the invention, this objective is achieved with a printhead comprising the features of claim 1 and a method comprising the features of claim 18. The respective dependent claims relate to further advantageous and potentially inventive embodiments.

The core idea of the invention is that a single common plunger is assigned to all nozzles of one nozzle set.

The printhead according to the present invention is a printhead for an inkjet printer, wherein the printhead includes at least one ink supply channel and at least one nozzle with a nozzle channel and an inflow opening, through which ink is pressed from the ink supply channel into the nozzle channel and expelled from it wherein the nozzle is fixedly arranged on a side wall of the ink supply channel, and the at least one nozzle is associated with a plunger whose plunger face lies within the ink supply channel and is spaced apart from the inflow opening, wherein the printhead includes first means for moving the plunger face within the ink supply channel between a reversal point (U1) that is minimally spaced from the nozzle's inflow opening and a reversal point (U2) that is maximally spaced from it, wherein the first means restrict the plunger face's movement to the range between these two reversal points (U1, U2) and second means are provided for applying a negative pressure to the ink in the ink supply channel relative to ambient air pressure wherein at least one set of said nozzles is present, which includes the one nozzle.

According to the invention, a single common plunger is assigned to all nozzles of the one nozzle set.

A nozzle set includes a predetermined plurality of nozzles.

The negative pressure prevents ink from unintentionally leaking out of the ink supply channel and nozzle channels. This eliminates the need for a closure element. To expel ink from all nozzles in the one nozzle set, the plunger provided in the ink supply channel is used. Its face moves toward the nozzle channels of the nozzle set, thereby pressing ink through and out of these nozzle channels wherein preferably, during the entire printing process, a defined distance is maintained between the plunger and the nozzles—i.e., the plunger face at the reversal point has a distance from the inflow openings of greater than zero, and the inflow openings of the nozzles in the one nozzle set remain permanently open throughout the printing process. The inventive plunger therefore explicitly does not function as a closure element.

The inventive printhead also makes it possible to use inks that span a wide viscosity range and/or contain particles.

This is particularly advantageous because the plunger does not need to function as a closure element, and the ink and/or particles sliding between the plunger face and the inflow openings of the nozzle channels of the nozzle set do not cause interference.

Accordingly, in a preferred embodiment, at the minimally spaced reversal point (U1), the distance at every point between the plunger face and each inflow opening of every nozzle in the nozzle set is greater than zero.

This design provides the advantage that collisions between the plunger and the nozzles can be prevented, thereby increasing the service life of the plunger, the first means, and the printhead itself.

According to another preferred embodiment, the first means include at least a first and second actuator, with the plunger being operatively connected at a first section via a first plunger rod to a first control element of the first actuator, and at a second section via a second plunger rod to a second control element of the second actuator, wherein the first and second sections are preferably spaced apart in a direction perpendicular to the nozzle axis of a nozzle in the nozzle set.

This embodiment provides the advantage of enabling a more compact design of the first means. The reduced space requirement in turn allows for a higher print resolution of the printhead, which enhances productivity with respect to the amount of ink discharged per unit of time.

Furthermore, it is possible for the one nozzle set to include at least thirty nozzles, preferably at least fifty nozzles, and particularly preferably at least seventy nozzles, arranged most preferably in one or more rows.

Furthermore, it is naturally possible for the one nozzle set to include thirty nozzles, preferably fifty nozzles, and particularly preferably seventy nozzles, arranged most preferably in one or more rows.

When at least thirty nozzles are assigned to a single common plunger that is operatively connected to at least two actuators, the common plunger cooperates synergistically with said nozzles in such a way that the total energy consumed for ejecting droplets of a defined size from each of the multiple nozzles is significantly lower than the sum of energies that would be consumed if each nozzle were operated by an individual plunger connected to its own actuator.

Thus, the printhead according to the invention enables energy-efficient control of a nozzle set for ink discharge.

An actuator is generally a device that converts electrical signals into mechanical motion or other physical quantities. In the context of the present invention, actuators convert electrical signals into mechanical motion.

In a preferred embodiment, the first actuator is designed to move one end of the first section of the plunger face within the ink supply channel between the minimally spaced reversal point (U1) and the maximally spaced reversal point (U2) relative to the inflow opening of one nozzle of the nozzle set and the second actuator is designed to move one end of the second section of the plunger face between a minimally spaced reversal point (U3) and a maximally spaced reversal point (U4).

Furthermore, the second actuator can be configured to limit the movement of the second end of the plunger face to the range between reversal points (U3, U4), and the first actuator to the range between (U1, U2).

The end of the first section may be a free end of the plunger face, and the end of the second section may be an opposite free end of the plunger face.

It is also possible for the distance between the end of the first section and the inflow opening of a nozzle in the nozzle set at the maximally spaced reversal point (U2), and the distance between the end of the second section and the inflow opening at the maximally spaced reversal point (U4), to be adjustable via a respective positioning arrangement for the actuator.

This provides the advantage of allowing simple regulation of the ink discharge amount across all nozzles in the set.

Alternatively, it is also possible for the distance between the end of the first section and the inflow opening at the minimally spaced reversal point (U1), and the distance between the end of the second section and the inflow opening at the minimally spaced reversal point (U3), to be adjustable via a respective actuator positioning arrangement.

An example of such an actuator positioning arrangement is disclosed in WO2019042586A1, published by the same applicant.

Furthermore, the positions of the reversal point (U2) as a starting point and the following reversal point (U1), as well as the reversal point (U4) and the following reversal point (U3), can be chosen such that a plunger stroke expels a predetermined, and preferably substantially identical, volume of ink and droplet size from each nozzle in the nozzle set.

Inclinations of the ink supply channel's side wall, which can often not be avoided due to natural manufacturing tolerances of all assembly components, may cause different nozzles in the set to discharge droplets of varying sizes.

These embodiments therefore offer the advantage that, even if the side wall of the ink supply channel that includes the nozzles is inclined, a coating with high uniformity across the nozzle set's width can still be achieved. As a result, a more homogeneous ink layer thickness on the print medium can be produced.

According to a preferred embodiment, the actuators are designed and controlled such that the movement of the plunger face is effected by synchronous movement of the first and second plunger rods.

The plunger rods can each be rigidly connected to the plunger, preferably via a form-fit connection and/or a suitable material-locking connection. The form-fit connection may be designed as a snap-fit or screw connection. The material-locking connection may be designed as an adhesive bond. An adhesive bond includes the plunger rod as the first bonding partner, the plunger as the second bonding partner, and a suitable adhesive.

If the interlocking bonding partners, which means the plunger and the plunger rod, are also adhesively bonded together, a connection can be achieved that prevents any relative movement between the first and second bonding partners.

The plunger can be divided into a central region and two opposite edge regions, preferably along a longitudinal axis of the plunger, with the first section lying in the first edge region and the second section in the second, opposite edge region wherein the plunger is particularly preferably elongated in shape.

Each control element may be designed as a bending actuator, preferably a piezoelectric bending actuator.

Furthermore, at the minimally spaced reversal points (U1) and (U3), the distance at every point between the plunger face and each inflow opening of every nozzle in the nozzle set is greater than the particle size of particles in a particle-containing ink.

Accordingly, the ink supply channel may be filled with an ink containing particles. The ink may be a glaze suspension.

Additionally, the distance at the minimally spaced reversal point (U1) and the minimally spaced reversal point (U3) at every location between the plunger front side and each inflow opening of each nozzle of the one nozzle set may exceed the volumetric particle size diameter d99 (v), preferably more than twice the volumetric particle size diameter d99 (v).

The aforementioned refinements offer the advantage that fragmentation of particles in the affected nozzle inflow areas can be at least partially, preferably completely, prevented. Consequently, the service life of the plunger, the first means, and the print head can be increased.

Third means for pumping the ink through the ink supply channel may be provided, preferably permanently, and particularly in the effective area of the plunger in one flow direction, in order to prevent sedimentation of the ink in the ink supply channel.

Furthermore, it is possible that several sets of said nozzles are present, whereby all nozzles of the respective set of nozzles are assigned a single common respective plunger.

According to a preferred embodiment, no side wall is formed as one piece with any of the nozzles of the set, and a front face of the nozzles surrounding each inflow opening is flush with an inner surface of a side wall of the ink supply channel, which side wall is in contact with the ink.

According to another preferred embodiment, however, the side wall of the ink supply channel is formed as one piece with at least each nozzle of the at least one set of nozzles as a nozzle plate.

These refinements offer the advantage that a print head with higher printing resolution can be provided.

According to a particularly preferred embodiment, an actuator comprises a base body and a plunger, where the base body includes a base wall and a circumferential wall that together form a container enclosing a space, which can be sealed by a cover element, where the base wall has a through-opening for a plunger rod connected to the plunger, through which the plunger rod protrudes, and a control element is arranged inside the base body, which is also connected to the plunger rod where the control element is designed as a bending actuator, which is divided into a central and an edge region, with at least a part of its edge region arranged on the base body, and the plunger rod connected to the central region of the bending actuator.

An inkjet printer according to the invention comprises multiple print heads as described, and the inkjet printer includes shared second means for applying a negative pressure to the ink in each ink supply channel of each print head relative to ambient atmospheric pressure.

According to the invention, the objective is also achieved by a method for conducting printing processes as defined in claim 17.

The inventive method for conducting printing processes includes the following steps:
a) Providing a print head with an ink supply channel, a plunger, and a nozzle with a nozzle channel and inflow opening that connects the nozzle channel to the ink supply channel;
b) Filling the ink supply channel with ink;
wherein during the time intervals when no printing is to occur, the ink supply channel is subjected to a negative pressure at least in the area of the inflow opening of the nozzle relative to ambient atmospheric pressure, thereby preventing ink from escaping the nozzle channel even in the absence of a sealing element, and wherein the ink supply channel is provided with at least one set of said nozzles, including the one nozzle.

According to the invention, the method is characterized in that all the nozzles of the one set of nozzles are assigned a single common plunger, wherein to eject the ink a front face of the plunger is moved from a starting point toward all the inflow openings of the nozzles of the one set of nozzles.

According to a preferred embodiment of the method, the plunger face is moved only up to a first reversal point (U1) toward the inflow opening of one nozzle of the set, with the distance between the plunger face and each inflow opening of every nozzle of the set being greater than zero at every point at reversal point U1.

It is also possible that the one set of nozzles includes at least thirty nozzles, preferably at least fifty, particularly preferably at least seventy nozzles, which are most preferably arranged in one or more rows.

Furthermore, it is naturally possible for the one nozzle set to include thirty nozzles, preferably fifty nozzles, and particularly preferably seventy nozzles, arranged most preferably in one or more rows.

According to a further preferred embodiment of the method, after reaching the first reversal point (U1), the plunger face is moved away from the inflow opening of the nozzle of the set to a second reversal point (U2), which forms the starting point for the subsequent printing cycle.

According to a particularly preferred embodiment of the method, the positions of the starting point and the following reversal point (U1) are chosen such that the plunger stroke ejects a predetermined volume of ink and thus a droplet size from each nozzle in the set.

Typically, the plunger changes direction at the reversal points (U1) and (U2) at a predefined, preferably constant frequency, when a print medium is to be coated.

According to a preferred method, the first means comprise at least a first and second actuator, with the plunger being functionally connected at a first section via a first plunger rod to a first control element of the first actuator and at a second section via a second plunger rod to a second control element of the second actuator, wherein the first and second sections are spaced apart, particularly in a direction perpendicular to the nozzle axis.

This refinement offers the advantage of enabling a more space-saving design of the first means. As a result, the reduced space requirement allows for higher printing resolution, which in turn can increase the print head's productivity in terms of ink output per unit time.

It is thereby possible that one end of the first section of the plunger face is moved only up to the first reversal point (U1) by the first actuator, and one end of the second section of the plunger face is moved only up to a third reversal point (U3) by the second actuator.

Furthermore, after reaching reversal point (U1), the one end of the first section of the plunger face is moved away from the inflow opening of the nozzle of the set by the first actuator to the second reversal point (U2); after reaching reversal point (U3), the one end of the second section of the plunger face is moved away from the inflow opening by the second actuator to a fourth reversal point (U4), with (U2) and (U4) forming the starting points for the next printing cycle.

It is further possible that the position of the second reversal point (U2) and the subsequent first reversal point (U1), and the position of the fourth reversal point (U4) and the subsequent third reversal point (U3), may be selected such that the plunger stroke ejects a predetermined and preferably essentially identical amount of ink and thus droplet size from each nozzle of the one set of nozzles.

These refinements offer the advantage that, even if for example the nozzle-bearing side wall of the ink supply channel is inclined due to manufacturing tolerances, a coating with high homogeneity across the width of the nozzles in the set can still be achieved. As a result, a print medium can be coated with a more uniform ink layer thickness.

A plunger stroke between the respective reversal points, i.e. the distance traveled by the plunger face between the respective reversal points, may be in the range of 30 μm to 90 μm, preferably 40 μm to 80 μm, and most preferably between 50 μm and 70 μm.

According to a preferred method, the movement of the plunger face is effected by synchronous movement of the first and second plunger rods using the first and second actuators.

The ink can be pumped through the ink supply channel, preferably continuously.

According to a preferred embodiment, the plunger/nozzle distance at the first reversal point (U1) and if given at the third reversal point (U3) is between 80 μm and 400 μm, preferably between 200 μm and 280 μm, and particularly preferably between 220 μm and 260 μm.

In a preferred embodiment, the distance between the plunger face and each inflow opening of each nozzle of the set at the first (U1) and third (U3) reversal points is greater than the particle size of the particles in a particle-containing ink. Accordingly, the ink supply channel can be filled with particle-containing ink. The ink may be a glaze suspension.

Each control element may be configured as a bending actuator, preferably as a piezoelectric bending actuator.

It is also possible that when no voltage is applied to the bending actuator, the plunger face rests in a position that constitutes a start point and lies between the respective reversal points (U1, U2) and if given (U3, U4). Thus, the distance between the plunger face and the inflow opening of the nozzle at the start point may also be adjustable via a positioning arrangement for the actuator.

According to a preferred embodiment of the method, the method includes the steps:
Transporting at least one print medium along a transport direction such that it is moved into and out of the effective range of the print head;
Coating the at least one print medium by reversing the direction of the plunger at the first reversal point (U1), or, if given, reversing the direction of the end of the first section of the plunger face at the first reversal point (U1) and the end of the second section of the plunger face at the third reversal point (U3), with a predefined, preferably constant frequency, preferably ≥1 kHz, and more preferably ≥2 kHz.

According to a more general preferred embodiment of the method, the method comprises the steps:
Coating at least one print medium using the print head by reversing the direction of the plunger at the first reversal point (U1), or where applicable reversing the direction of the end of the first section of the plunger face at (U1) and the end of the second section at (U3), at a predefined, preferably constant, frequency of preferably ≥1 kHz, particularly ≥2 kHz;
Wherein a continuous unidirectional relative movement between the print head and the at least one print medium occurs during coating.

According to a particularly preferred embodiment, the plunger face is elongate, with two opposing elongate longitudinal edges delimiting the plunger front face, wherein two plates are provided in the ink supply channel, each standing on one of their edges relative to the side wall of the ink supply channel, at which all nozzles of the one set of nozzles are arranged and positioned at a specified distance from the side wall in such a way, that the lateral surfaces, which are fictitiously travelled by the movement of the elongated longitudinal edges in the ink, are flanked by the inner side of the respective plates facing the respective elongated longitudinal edge at a predetermined distance, wherein the plates are dimensioned sufficiently large, and the said distances are chosen in such a way that during coating of a print medium a coating is produced on the print medium which has a higher homogeneity than a coating which can be produced under otherwise identical conditions but with other corresponding distances and smaller dimensioned plates.

Homogeneity of the coating, in the context of the invention, refers to the uniformity of an evaluable attribute of the coating, particularly banding effects, across the analyzed area. Banding effects are known visible defects in coating quality and are characterized by abrupt or gradual transitions in coating attributes, such as gloss or layer height, where no such transitions are desired.

This refinement is advantageous because it ensures the production of coated print media with less waste, regardless of the actual spatial dimensions of the ink supply channel.

Although the inventor does not wish to be bound by any particular theory, it is believed that the invention can reduce turbulent ink flow in the effective area of the plunger face.

There are different ways by which the expert can determine suitable distances and sufficiently large dimensioning of the plates. For example, in a first series of tests, he can carry out ink ejection passes with constant but respectively different, in particular increasingly smaller, distances between the edges of the preselected plates and the mentioned side wall, with a predetermined distance between the inside of each plate and the respective longitudinal edges of the plunger front face, and thus check whether, and if so at which distance or distances, an acceptable coating or application is possible. This or one of these distances is then set as the predetermined distance of the respective edge of the plates to the side wall.

If no acceptable coating or application is achieved, the respective preselected distance between the inside of each plate and the respective longitudinal edges of the plunger front face is to be selected larger or smaller in a second series of tests until, by repeating the first test series with the newly selected distance of the inner sides of respective plates to the respective longitudinal edges of the plunger's front face, suitable distances and thus acceptable coating are obtained.

If still no acceptable coating or application is achieved, the size of the plates is increased in a third series of tests, and the first and, if applicable, second test series are repeated until the desired result is reached.

A plate is preferably sufficiently large when its height, which is oriented parallel to the direction of the plunger stroke, is at least 50 times the stroke distance traveled by the plunger, and its length, which is oriented perpendicular to the height, corresponds at least to the length of a longitudinal edge of the plunger front face.

Preferably, the height of the plate is at least 150 times, and especially preferably at least 500 times, the stroke distance traveled by the plunger.

However, the expert may also start conversely by initially conducting a test series with constant but respectively different distances of the inside of the plates to the respective longitudinal edges of the plunger front face, with a predetermined distance of the edge of the respective preselected plates to the side wall, and check whether, and if so at which distance or distances, an acceptable coating or application is possible. This distance or one of these distances is then set as the predetermined distance of the inside of the respective plates to the respective longitudinal edges.

If no acceptable coating or application is achieved, at least one of the two other parameters is adjusted with further test series until an acceptable result is obtained.

According to a particularly preferred embodiment, the said plates are dimensioned so large and the said distances are chosen such that a waste-free coating of a print medium is ensured, whereas, compared to the respective distances, certain other corresponding distances and possibly smaller dimensioned plates would have led to a wasteful print medium.

This improvement is advantageous because it ensures the production of waste-free print media independently of the actual spatial dimensions of the ink supply channel. As a result, drops of essentially identical size are ejected through all nozzles of one nozzle set.

The elongated plunger front face preferably has a rectangular shape, whose two opposite elongated longitudinal edges are oriented parallel to each other and connected by two opposite shorter edges, which are shorter than the longitudinal edges. A rectangular plunger front face may, for example, have the profile of a rectangle or a parallelogram.

Furthermore, it is possible that the plates each have such a height that they are in contact with the side wall of the ink supply channel opposite the side wall on which all nozzles of one nozzle set are arranged.

Typically, both the elongated plunger front face and the two plates are oriented essentially parallel to the flow direction of the ink in the ink supply channel. In this preferred embodiment, it is particularly preferred that the plates are arranged on the side wall of the ink supply channel such that the flow of ink between the two plates is not or not substantially hindered in the flow direction. The plates may also be directly connected to each other.

The respective distance between the edges of the plates and the side wall is preferably chosen larger than the plunger/nozzle distance at the first reversal point (U1) and, if applicable, at the third reversal point (U3), thereby further increasing the reliability of forming a homogeneous coating.

Furthermore, it is possible to provide a printer with at least two print heads, whereby each print head applies a strip of ink with a printing width, and the first and second print heads are arranged relative to each other so that the width of the ink strips essentially corresponds to the sum of the strip widths of both print heads.

According to a preferred embodiment, the method is characterized by producing a relief-like decoration with areas considered as recesses and areas considered as elevations on the print medium, wherein the method comprises the steps:
Applying a liquid composition repellent to water-based ink onto the areas considered as recesses on the print medium with a first resolution, followed by.
Printing the water-based ink with the print head at a second resolution either exclusively on the areas considered as elevations or exclusively on the areas considered as elevations and on the edge areas of the areas considered as recesses, whereby the first resolution is at least four times, preferably at least eight times, higher than the second resolution.

This improvement offers the advantage that relief-like decorations with high imaging accuracy can be achieved, and in addition that areas considered as recesses in the relief-like decoration can be produced which are always free of ink, thus achieving high print quality. This advantageous technical effect is particularly noticeable after firing a ceramic print medium. Moreover, this advantageous effect is ensured even when the respective areas considered as recesses are so large that otherwise, i.e., even when ink is printed on the respective middle areas of the recess areas, the effect caused by the water-based ink-repellent liquid composition, namely pushing the water-based ink out of the recess areas toward the edge, can no longer be ensured.

An edge area of an area considered as a recess is understood as an edge area defined by a fictitious edge of the recess area spaced from the actual edge and preferably spaced up to 1.5 cm, especially preferably up to 1.0 cm, particularly preferably up to 0.5 cm from the actual edge, whereby the said edge area defines and encloses a corresponding middle area of the recess area but does not overlap with it.

The expert is familiar with the corresponding water-based ink-repellent liquid compositions known from the prior art.

The application of the ink-repellent composition can be done with an inkjet print head with nozzles, wherein each individual nozzle can be controlled separately.

A water-based ink-repellent liquid composition is typically hydrophobic.

A ceramic print medium can be provided as the print medium.

The ink may be a suspension, preferably a glaze suspension, especially a water-based glaze suspension, which is particularly preferably a non-Newtonian fluid. As stated above, the ink can also be a water-based ink.

Furthermore, it is possible that the ceramic print medium with its relief-like decoration is fired to produce a baked-in relief-like decoration on the surface of the print medium if a glaze suspension is used as ink.

According to a preferred embodiment, after drying the water-based ink and the water-based ink-repellent liquid composition on the print medium, a motif is applied to the areas considered as recesses and/or to the areas considered as elevations using at least one inkjet print head with nozzles, each individually controllable.

This improvement has the advantage that the correspondence between certain relief features and the printed motif leads to a high-quality motif, especially a natural impression of the motif to be depicted, such as specific stone motifs or wood motifs.

The method can be applied to coating at least one ceramic print medium with a glaze or engobe or smaltobe as ink, each in the form of a suspension, by applying it to the at least one ceramic print medium and then at least partially constricting it.

From the prior art, layer-wise slip deposition methods for manufacturing a three-dimensional object are known. For example, a corresponding method for layer-wise building of a three-dimensional green body is known comprising the steps: (i) providing an elongated casting nozzle; (ii) applying a slip onto a surface to form a slip layer by moving the casting nozzle back and forth between two opposite positions while slip is poured from the elongated opening of the casting nozzle, followed by drying the layer to a powder layer; (iii) consolidating the powder of the powder layer at the positions corresponding to the cross-section of the green body; and (iv) repeating steps (ii) and (iii) until the green body is formed.

A problem causing high material consumption is the fact that in the currently known layer-wise slip deposition methods for producing three-dimensional objects, only the above-described production method is realized. There are three-dimensional objects where nearly every layer has relatively small powder areas to be consolidated and correspondingly relatively large areas not to be consolidated (free areas). When a casting nozzle is moved over a free area of a row, it still pours slip over the entire build area width. This layer buildup leads to high slip consumption since its dried form is currently not or only with considerable effort recyclable. This is especially relevant when the immutable build area width is relatively large and only very small areas per layer are part of the green body.

It would therefore be desirable to have a layer-wise slip deposition method available that keeps material consumption low regardless of the object size.

The present invention thus also aims to provide a method for layer-wise manufacturing of a green body with low material consumption, thereby providing a more sustainable method.

The task is solved by the method according to claim 32.

Accordingly, according to a preferred embodiment, the method is characterized by, for producing a three-dimensional green body, comprising the steps:
c) Filling the ink supply channel with ink, which is a ceramic and/or metallic slip;
d) Printing the slip onto a specific surface to form a layer of a green body with the printhead by ejecting the slip from all nozzles of one set of nozzles at a predetermined, preferably constant frequency, and drying the layer to form a powder layer;
e) Consolidating the powder of the powder layer at the locations corresponding to the cross-section of the green body;
f) Repeating steps d) and e) until the green body is completely manufactured.

This causes drops of slip to be ejected with each ejection from all nozzles of one set of nozzles. As described above, the ejection of the slip takes place by moving the front face of the plunger from a starting point over all inflow openings of the nozzles of one set of nozzles of the printhead. Accordingly, during the corresponding printing, a direction change of the plunger preferably occurs at the first reversal point (U1), or if applicable, a direction change of one end of the first section of the plunger face at the first reversal point (U1) and of one end of the second section of the plunger face at the third reversal point (U3), at a predetermined, preferably constant frequency.

Typically, the green body is removed from the non-consolidated powder before firing it into a sintered three-dimensional object.

According to a preferred embodiment, the consolidation is carried out by applying drops of a fixing liquid at the locations corresponding to the cross-section of the green body using an inkjet printhead with nozzles, where each individual nozzle is separately controllable.

Furthermore, it is possible that the fixing liquid comprises or consists of an organic binder.

The fixing liquid, in particular the organic binder, has the property of form-fittingly holding together and especially bonding the consolidated ceramic and/or metallic particles and layers.

Typically, the ceramic and/or metallic slip comprises one or more additives, for example at least one dispersing agent and/or at least one organic binder, which preferably differs from the organic binder of the fixing liquid.

According to a preferred embodiment, the inkjet printhead with nozzles, where each individual nozzle is separately controllable, is designed to eject drops of the fixing liquid with a drop volume of ≤100 pl each, preferably ≥10 pl and ≤80 pl, particularly preferably ≥20 pl and ≤45 pl each.

According to a preferred embodiment, the printhead is designed to eject drops of the slip with a drop volume each being at least 15 times, preferably at least 50 times, particularly preferably at least 150 times, and very particularly preferably at least 300 times the volume of the drops of the fixing liquid from the inkjet printhead with nozzles where each individual nozzle is separately controllable.

According to a preferred embodiment, all nozzles of at least one set of nozzles have a nozzle inner diameter between 100 μm and 400 μm, preferably between 100 μm and 250 μm, which allows printing suspensions with larger particles compared to the otherwise typical piezoelectric inkjet printing devices from the prior art, which typically have nozzles with an inner diameter of up to only 60 μm.

According to a particularly preferred embodiment of the method, an inkjet printer for manufacturing a three-dimensional object is provided comprising multiple inventive printheads, wherein the inkjet printer further comprises common second means for applying a negative pressure relative to the ambient air pressure to the ink in each ink supply channel of each printhead, and wherein the inkjet printer is also provided with multiple inkjet printheads with nozzles, where each individual nozzle is separately controllable.

1. A printhead for an inkjet printer, wherein the printhead comprises at least one ink supply channel and at least one nozzle with a nozzle channel and an inflow opening, through which ink can be pressed from the ink supply channel into the nozzle channel and ejected therefrom, wherein the nozzle is fixedly arranged on a sidewall of the ink supply channel and the at least one nozzle is assigned a plunger having a plunger front face located in the ink supply channel opposite and spaced from the inflow opening, wherein the printhead comprises first means for moving the plunger front face in the ink supply channel between a reversal point (U1) minimally spaced from the inflow opening of the nozzle and a reversal point (U2) maximally spaced from the inflow opening of the nozzle, the first means limiting the movement of the plunger front face to a movement between the reversal points (U1, U2), and second means for applying a negative pressure to the ink in the ink supply channel relative to ambient air pressure, wherein at least one set of said nozzles is provided comprising the one nozzle, characterized in that a single common plunger is assigned to all nozzles of the one set of nozzles.

2. The printhead according to claim 1, wherein the minimally spaced reversal point (U1) the distance at every point between the plunger front face and each inflow opening of each nozzle of the one set of nozzles is greater than zero.

3. The printhead according to claim 1, wherein one set of nozzles comprises at least thirty nozzles, preferably at least fifty nozzles, particularly preferably at least seventy nozzles.

4. The printhead according to claim 1, wherein the first means comprise at least a first and a second actuator, wherein the plunger is operatively connected at a first section of the plunger via a first plunger rod to a first actuator element of the first actuator and at a second section of the plunger via a second plunger rod to a second actuator element of the second actuator, wherein the first and second sections are spaced apart in a direction perpendicular to the nozzle axis of a nozzle of the one set of nozzles.

5. The printhead according to claim 4, wherein the first actuator is designed to move one end of the first section of the plunger front face in the ink supply channel between the reversal point (U1) minimally spaced from the inflow opening of a nozzle of the one set of nozzles and the reversal point (U2) maximally spaced from the inflow opening of the same nozzle, and the second actuator is designed to move one end of the second section of the plunger front face in the ink supply channel between a reversal point (U3) minimally spaced from the inflow opening of the same nozzle and a reversal point (U4) maximally spaced from the inflow opening of the same nozzle.

6. The printhead according to claim 5, wherein the second actuator limits the movement of the one end of the second section of the plunger front face to a movement between the reversal points (U3, U4), and the first actuator limits the movement of the one end of the first section of the plunger front face to a movement between the reversal points (U1, U2).

7. The printhead according to claim 5, wherein position of the reversal point (U2) as a starting point and the following reversal point (U1), as well as the position of the reversal point (U4) as a starting point and the following reversal point (U3), are chosen such that a plunger stroke can eject a predetermined and preferably essentially identical amount of ink, and thus drop size, from each nozzle of the one set of nozzles.

8. The printhead according to claim 4, wherein the actuators are designed and controllable such that the movement of the plunger front face is effected by synchronous movement of the first and second plunger rods.

9. The printhead according to claim 4, wherein the plunger rods are each firmly operatively connected to the plunger, preferably by a form-fit connection and/or a material-locking connection.

10. The printhead according to claim 4, wherein the plunger is subdividable into a middle area and two opposing edge areas, preferably along a longitudinal axis of the plunger, wherein the first section is located in the first edge area and the second section is located in the second edge area opposite the first edge area, the plunger being particularly preferably of elongated design.

11. The printhead according to claim 4, wherein each actuator element is configured as a bending transducer, preferably as a piezoelectric bending actuator.

12. The printhead according to claim 5, wherein the minimally spaced reversal points (U1) and (U3), the distance at every point between the plunger front face and each inflow opening of each nozzle of the one set of nozzles is greater than a particle size of particles of a particle-containing ink.

13. The printhead according to claim 1, wherein a third means are provided for pumping the ink through the ink supply channel of the printhead, preferably permanently, in particular at least in the effective range of the plunger in one flow direction.

14. The printhead according to claim 1, wherein several sets of said nozzles are provided, whereby all nozzles of the respective set of nozzles are each assigned a single common plunger.

15. The printhead according to claim 1, wherein the sidewall of the ink supply channel is integrally formed with at least each nozzle of the at least one set of nozzles as a nozzle plate.

16. An inkjet printer comprising several printheads according to claim 1, wherein the inkjet printer comprises common second means for applying a negative pressure to the ink in each ink supply channel of each printhead relative to ambient air pressure.

17. A method for carrying out printing processes comprising the steps of:
a) providing a printhead with an ink supply channel, a plunger, and a nozzle with a nozzle channel and inflow opening forming the connection between the nozzle channel and the ink supply channel;
b) filling the ink supply channel with ink;
wherein at least during the time intervals when no printing is to be performed, the ink supply channel is acted upon at least in the region of the inflow opening of the nozzle with a negative pressure relative to ambient air pressure, thereby preventing ink from flowing out of the nozzle channel even without a closure body, wherein the ink supply channel is provided with at least one set of said nozzles comprising the one nozzle, characterized in that all nozzles of the one set of nozzles are assigned a single common plunger, wherein to eject the ink a front face of the plunger is moved from a starting point towards all inflow openings of the nozzles of the one set of nozzles.

18. The method according to claim 17, wherein a front face of the plunger is moved only up to a first reversal point (U1) towards the inflow opening of the one nozzle of the set of nozzles, wherein at the first reversal point (U1) the distance at every point between the plunger front face and each inflow opening of each nozzle of the one set of nozzles is greater than zero.

19. The method according to claim 17, wherein the one set of nozzles comprises thirty nozzles, preferably fifty nozzles, particularly preferably seventy nozzles.

20. The method according to claim 17, wherein after reaching the first reversal point (U1), the front face of the plunger is moved away from the inflow opening of the one nozzle of the one set of nozzles to a second reversal point (U2), which forms the starting point for the subsequent printing cycle.

21. The method according to claim 20, wherein the position of the starting point and the subsequent reversal point (U1) is chosen such that the plunger stroke ejects a predetermined amount of ink and thus drop size from each nozzle of the one set of nozzles.

22. The method according to claim 17, wherein the first means are provided with at least a first and a second actuator, wherein the plunger is operatively connected at a first section of the plunger via a first plunger rod to a first actuator element of the first actuator and at a second section of the plunger via a second plunger rod to a second actuator element of the second actuator, wherein the first and second sections are spaced apart particularly in a direction perpendicular to the nozzle axis.

23. The method according to claim 22, wherein one end of the first section of the plunger front face is moved by the first actuator only up to the first reversal point (U1) towards the inflow opening of the one nozzle of the set of nozzles, and one end of the second section of the plunger front face is moved by the second actuator only up to a third reversal point (U3) towards the inflow opening of the one nozzle of the set of nozzles.

24. The method according to claim 23, wherein after reaching the first reversal point (U1) by one end of the first section of the plunger front face, this is moved away from the inflow opening of the one nozzle of the one set of nozzles by the first actuator to the second reversal point (U2), and after reaching the third reversal point (U3) by one end of the second section of the plunger front face, this is moved away from the inflow opening of the one nozzle of the one set of nozzles by the second actuator to the fourth reversal point (U4), wherein the reversal points (U2) and (U4) each form the starting point for the subsequent printing cycle.

25. The method according to claim 24, wherein the positions of the second reversal point (U2) and the subsequent first reversal point (U1), and the positions of the fourth reversal point (U4) and the subsequent third reversal point (U3), are chosen such that the plunger stroke ejects a predetermined and preferably essentially identical amount of ink and thus drop size from each nozzle of the one set of nozzles.

26. The method according to claim 22, wherein the movement of the plunger front face is effected by synchronous movement of the first and second plunger rods by means of the at least first and second actuators.

27. The method according to claim 17, wherein the ink is pumped through the ink supply channel, preferably permanently.

28. The method according to claim 17, wherein at the first reversal point (U1) and the third reversal point (U3), the distance at every point between the plunger front face and each inflow opening of each nozzle of the one set of nozzles is greater than a particle size of particles of a particle-containing ink.

29. The method according to claim 17, further comprising the following steps:
transporting at least one printing medium along a transport direction such that the printing medium is moved into and out again of the effective range of the printhead;
coating the at least one printing medium, wherein a direction change of the plunger at the first reversal point (U1), or if given a direction change of one end of the first section of the plunger front face each at the first reversal point (U1) and one end of the second section of the plunger front face at the third reversal point (U3), is performed at a predetermined, preferably constant, frequency.

30. The method according to claim 17, wherein the ink is a suspension, preferably a glaze suspension, particularly preferably a non-Newtonian fluid.

31. The method according to claim 17, wherein the at least one printing medium is provided as a ceramic printing medium.

32. The method according to claim 1, for producing a three-dimensional green body, comprising the steps of:
c) filling the ink supply channel with ink which is a ceramic and/or metallic slip;
d) printing the slip on a specified surface to form a layer of a green body using the printhead by ejecting the slip from all nozzles of the one set of nozzles at a predetermined, preferably constant, frequency, and drying the layer to a powder layer;
e) consolidating the powder of the powder layer at the locations corresponding to the cross-section of the green body;
f) repeating steps d) and e) until the green body is produced.

33. The method according to claim 32, wherein the consolidating is performed by applying droplets of a fixing liquid at the locations corresponding to the cross-section of the green body with an inkjet printhead having nozzles, each nozzle being individually controllable.

34. The method according to claim 32, wherein the fixing liquid comprises or consists of an organic binder.
